(19) United States
(12) Patent Application Publication
(10) Pub. No.: US 2025/0012674 A1
(43) Pub. Date: Jan. 9, 2025

(54) Synchronization of Measurement Values Delivered in an Individual Measurement Phase for a Safety Function

(71) Applicant: Siemens Aktiengesellschaft, Müenchen (DE)

(72) Inventors: Minh LE, Bernburg (DE); Dominik BUDDAY, Erlangen (DE); Alexander STEIN, Veitsbronn (DE); Matthias MILITOR, Wiesengiech (DE); Peter ZITTLAU, Baiersdorf (DE)

(21) Appl. No.: 18/708,280

(22) PCT Filed: Oct. 27, 2022
(86) PCT No.: PCT/EP2022/080135

§ 371 Date: May 8, 2024

(30) Foreign Application Priority Data
Nov. 12, 2021 (EP) 21207988.3

(51) Int. Cl. G01M 99/00

(52) U.S. Cl. CPC G01M 99/005

(57) ABSTRACT

A safety-oriented control unit and method for synchronizing measurement values delivered in an individual measurement phase, wherein the measurement values are processed by the safety-oriented controller in a monitoring phase in accordance with a safety function, where individual counter increments of the measurement values are compared with one another in comparison during a current monitoring cycle of the monitoring phase with a previous monitoring cycle, a maximum counter increment is determined, the measurement values that do not have the maximum counter increment are adjusted based on the maximum counter increment, and where at least one monitoring value is established by the safety function based on the adjusted measurement value(s) and the measurement value(s) associated with the maximum counter increment.

### CROSS-REFERENCE TO RELATED APPLICATIONS

This is a U.S. national stage of application No. PCT/EP2022/080135 filed 27 Oct. 2022. Priority is claimed on European Application No. 21207988.3 filed 12 Nov. 2021, the content of which is incorporated herein by reference in its entirety.

### BACKGROUND OF THE INVENTION

### 1. Field of the Invention

The invention relates to a safety-oriented controller and a method for synchronizing measurement values supplied in a respective measurement phase, where the measurement values are processed by a safety-oriented controller in a monitoring phase in accordance with a safety function.

### 2. Field of the Invention

In many industrial automation applications, multiple drive axes are involved. For example, multiple axes of a multi-axis kinematics are involved in a movement and are actuated accordingly. Here, an overall movement, such as movement of an end effector, only results from the respective movement of the individual axes. Such movements often have to be performed safely, i.e., in compliance with safety requirements, which include the monitoring of compliance with position or speed limits, for example.

Similarly, in many applications, encoder or sensor values from a wide range of encoders or sensors within a system are processed to form a common value, such as a monitoring value, which is continuously determined and monitored for compliance with certain limit values.

In synchronous operation, the various measurement values are acquired in a uniform measurement phase, i.e., time-synchronously to one another.

Depending on the application and type of the installed components, however, such synchronized operation is not guaranteed. However, reliable values for monitoring a wide range of functions should also be generated for the asynchronous operation, in which a uniform measurement cycle phase or clock-synchrony is not guaranteed for the measurement or transmission of values or a non-clock-synchronous, cyclic retrieval of measurement values is carried out for further processing.

### SUMMARY OF THE INVENTION

In view of the foregoing, it is an object of the present invention to improve a safety function for measurement values acquired or processed in arbitrary ways, in particular asynchronously or non-clock-synchronously.

This and other objects and advantages are achieved in accordance with the invention by a method for synchronizing measurement values supplied in a respective measurement phase, where the measurement values are processed by a safety-oriented controller in a monitoring phase in accordance with a safety function, where respective counter increments of the measurement values are compared in a current monitoring cycle of the monitoring phase with one another in comparison with a previous monitoring cycle, and a maximum counter increment is determined, where the measurement values that do not have the maximum counter increment are adjusted based on the maximum counter increment, and where at least one monitoring value is formed by the safety function based on the adjusted measurement value(s) and the measurement value(s) associated with the maximum counter increment at.

The various acquired values are processed by the safety-oriented controller, which itself operates in a monitoring phase, in particular in order to continuously generate current monitoring values. If, for example, a non-deterministic process is used to invoke the measurement processing, i.e., a non-clock-synchronous, cyclic invocation of the measurement value processing to form the monitoring value, then jitter can occur. In addition, the values are acquired and/or delivered in a measurement phase, where an arbitrary number of the different measurement values is acquired and/or delivered in a separate measurement phase, in particular all at a different clock rate. Expressed differently, the clocks of the respective system in which the respective measurement values are acquired are not synchronized with each other, or diverge. It can also be expressed as the clocks between the measurement system and the monitoring system being not necessarily synchronized. In addition, “synchronization times” can be different or not constant, so that inherently synchronously acquired measurement values are received and further processed asynchronously for further processing for the monitoring value, in particular by a measurement value processing system. In addition, in a transmission system for transmitting the measurement values to the unit that forms the monitoring value, jitter may also occur due to non-equidistant transmission, for example, in the case of transmission via Ethernet.

Due to this temporal concurrency caused by different and in particular simultaneously occurring effects, multiple measurement values are available for forming a monitoring value in the safety-oriented controller that do not belong to a uniform time value or a uniform or common time point. For example, in the case of position values that are delivered in asynchronous axis operation, the information on the positions of the individual axes that are to be processed in a monitoring phase of the controller may be present in the controller at the same time, but refer to different points in time. This means that although the delivered positions were actually adopted by the respective axes, it is not guaranteed that the different position values are comparable with each other with respect to their time reference. Therefore, the information on the corresponding axis positions cannot be meaningfully combined to determine and monitor an overall adopted position value based on the interaction of the axes, for example, the position value of an end effector of a multi-axis kinematics.

The monitoring value is formed from at least two measurement values, i.e., it is a common or composite or combined monitoring value. The monitoring value can only be used to provide a meaningful statement about a state to be monitored, for example, a position or temperature or speed, which is dependent on multiple measurement values, if the respective measurement values provide a statement at a common point in time.

For this purpose, the adjustment is performed in accordance with the above-described method.

The individual measurement values are either processed directly or else one or more of the measurement values are first derived and input into the determination of the monitoring value in derived form. The result is therefore a combined or common monitoring value that is formed depending on a plurality of acquired values.

The plurality of acquired values is delivered, for example, by a plurality of locally installed sensors or encoders. For example, they are also provided at least in part by simulation programs or cloud-based applications.

For example, the measurement phase is specified by an acquisition unit for the respective value, such as the respective sensor. If the individual values to be acquired are axis values, such as axis positions, then the measurement phase is specified by the drive phase on the respective axis. Furthermore, the measurement phase is influenced, for example, by an existing bus, where the acquired values are then supplied at the bus clock rate and the bus clock rate then represents the measurement clock rate.

For example, the measurement values may be encoder or sensor values that relate to a movement of a device or machine controlled by the safety-oriented controller. For example, the monitoring of this movement is provided by the safety function.

The monitoring phase is specified by the safety-oriented controller. For example, the monitoring phase is specified by a movement cycle provided on the safety-oriented controller. For example, a safety module for safe movement monitoring runs on the same CPU as a motion control, for example, that of a robot, and has a higher clock rate than the motion control.

The respective counter increments enable the times elapsed since the last delivered value to be taken into account in the respective measurement systems, for example, on the respective axes. An absolute counter time is irrelevant. For example, in each bus cycle, all axis telegrams are made available to the safety controller, where all axes start with any initial counter value. Each axis, for example, has its own local clock in the form of a counter or timestamp, which increments by an integer number as time progresses. Here, the duration of an increment corresponds to the drive cycle.

The increments of the counters of the various values acquired in the current monitoring cycle are compared to one another to determine the most up-to-date value. The respective counter increments, such as the counter increments per axis, are determined by comparing the counter value in the current monitoring phase with a counter value of the measurement value in the previous monitoring phase. The counter value of the measurement value in the previous monitoring phase may be an adjusted counter value. This is the case if the adjustment procedure proposed here has already been performed in the previous monitoring phase. If there is still no adjusted measurement value available or if there was found to be no need for an adjustment in the previous monitoring cycle as a result of the counter increment comparison, then the counter value delivered with the measurement value delivered in the last monitoring phase is used directly to form the counter increment.

The maximum counter increment, also known as the global counter increment, of the respective counter increments, also known as local counter increments, ultimately defines for the current monitoring cycle the time to which the respective measurement values must be adjusted, in case they are not already the same as this time of the measurement value with the associated maximum counter increment.

Advantageously, using the disclosed method a plausible statement is made, for example, about a current axial position of the received telegram. In this way, the safety and availability in the system is advantageously maintained. More accurately predictable safety limits ensure a meaningful usage, i.e., with as little unnecessary caution as possible, with a high level of safety.

For example, all telegrams that are received, for example, from different axes involved are synchronized or modified such way that they are temporally consistent with one another. One can therefore also refer to the functionality of a telegram filter. Thus, a plausible value that is as close as possible to the actual existing monitoring value is determined for the dependent monitoring value overall when all, if necessary adjusted, measurement values are taken into account jointly.

The disclosed method enables a safety-oriented operation in asynchronous mode. Thus, movements of a multi-axis kinematics, for example, can be monitored in a safety-oriented manner without all the axes involved needing to be synchronized with regard to their respective drive and bus clock rates as well as with regard to a monitoring cycle. The associated opportunity obtained for asynchronous project planning allows for a wider range of use cases. For example, 6-axis kinematics, as typically used in machine tools, can be advantageously operated with comparable accuracy and availability of the safety functions as is available in synchronous mode.

The disclosed adjustment of the measurement values via the described filter functionality can in particular eliminate, quasi simultaneously, a number of effects that contribute to temporal concurrency and thus to inaccuracies in the determination of the monitoring value, whenever they occur: a possible temporal asynchrony due to a necessary synchronization of measurement values, acquired and processed in the safety cycle of a safety-oriented drive controller, with a communication cycle (even if this is itself clock-synchronous) as well as a possible asynchrony between this communication cycle and the non-clock-synchronous processing cycle of the safety function module in the motion controller, for example, a calling cycle of the application. In all stages, asynchronocities can occur along the pathway from acquisition and transmission of the measurement values up to the determination of the monitoring value, due to distributed and superimposed components. The adjustment of the measurement values advantageously eliminates any existing temporal concurrency.

In accordance with one embodiment, the measurement values are delivered in a common measurement cycle or in different measurement cycles in each case. For example, the measurement cycles of different encoders or sensors, which each deliver one of the measurement values that are used to form the monitoring value, are in principle in a common cycle, but nevertheless diverge for short phases and thus do not run synchronously. Furthermore, it is possible to monitor applications in a safety-oriented manner with high accuracy, in which although a common clock generator of the individual measurement values is present, for example, a common clock generator of all the axes involved so that they do not temporally diverge over the long term, but in which no synchrony is ensured for short time phases.

In other scenarios, the measurement phase is the same, but different bus or other transmission systems are involved that do not have a uniform clock rate. Again, in other scenarios, the measurement phases are different or completely unknown from the outset. For all the described initial situations, the proposed solution offers the certainty that measurement values will still be compared with one another or assigned to each other or used jointly for forming a common monitoring value, the at least potential asynchrony of which is taken into account, and thus leads to a more accurate monitoring value.

In accordance with another embodiment, the monitoring phase differs from the measurement phase or at least from individual measurement phases. For example, in each safety cycle, the safety controller samples the axis telegrams of the axes involved, the interaction of which is to be monitored, together with their counter values, for example, a current time stamp, and associated position values from the bus. Depending on how the ratio of the durations between the safety cycle and the bus cycle is set, either an oversampling of the telegrams will occur, i.e., bus cycle duration greater than the safety cycle duration, or an undersampling, i.e., bus cycle duration less than the safety cycle duration. In asynchronous axis mode, if the bus cycle and safety cycle have different time periods and if axis telegrams are read from the bus too often (oversampling) or too seldom (undersampling), then it is advantageous to reliably monitor the axial and especially the Cartesian positions as well as the speeds of multi-axis kinematics. Thus, the proposed filter functionality implemented by, for example, a CPU in the safety controller, takes into account an asynchrony between a communication cycle and a cyclic, but not clock-synchronous, processing cycle of a safety function module.

In accordance with one embodiment, the measurement values are delivered to the safety-oriented control system via a telegram. For example, this uses telegrams of a bus system that is used in a plant, for example, a production plant or a process plant, for the communicative connection of individual plant components or machines.

In accordance with a further embodiment, the measurement values of the respective axes of a multi-axis kinematics are delivered. In particular in the case of multi-axis kinematics, such as those often used in robotics applications, this provides the advantage that measurement values of different axes are required as input values to form a monitoring value that monitors a status or a state of the kinematics, for example, a position or velocity at an end effector. The different measurement values together produce the value to be monitored. In accordance with the presently contemplated embodiment, the measurement values of the various axes are synchronized with one another such that they match each other in time, i.e., that the values delivered belong to the same and thus comparable acquisition times. The disclosed embodiment can be used to ensure that the position or speed values that the kinematics have assumed with greater probability than without performing the adjustment are determined as accurately as possible and to avoid the risk of an inaccurate or incorrect position or speed being determined which, for example, the end effector was very likely never to have taken, due to the temporal concurrency of the drive axes involved. Therefore, the safety and reliability of the safety function is increased.

In accordance with another embodiment, the safety-oriented controller obtains the measurement values from distributed measurement systems. For example, the six axes of a typical 6-axis robot each deliver one measurement value. If the synchronization of these measurement systems with the communication cycle in which the safety-oriented controller receives the measurement values takes place in an uncoordinated manner and the acquisition of the values is performed at a lower rate than the communication cycle, this offset can be detected and corrected with the proposed adjustment, thus making the resulting derived monitoring value more precise. The measurement values are received, for example, by the safety controller of at least two Control Units (CUs) in distributed form from at least two axis drives and are therefore not provided in a time-synchronized form for the determination of the monitoring value.

With the proposed adjustment to a common counter value, the measurement values of the various CUs are synchronized with one another and the resulting derived monitoring value becomes more precise.

In the case of multiple CUs, these synchronize their safety cycle to the communication clock rate, where the synchronization in fact occurs generally uncoordinated to a more or less arbitrary communication phase, for example, whenever the drive is ready to do so. This can cause the one CU to synchronize to an even communication clock cycle, the other to an odd communication clock cycle, whereby the sensor data acquisition on the two CUs is shifted by one communication clock cycle. However, both CUs must still be regarded in particular as clock-synchronous. For example, the drive safety cycle is reduced to the communication cycle with a communication cycle of 4 ms and a drive safety cycle of 8 ms. The CU then supplies the same counters and values in two consecutive communication cycles. The proposed adjustment procedure can detect this because the cycle counters are now incrementing at different rates.

| Communication cycle: | 1 | 2 | 3 | 4 | 5 | 6 | 7 |
|---|---|---|---|---|---|---|---|
| Drive1 counter: | 1 | 1 | 2 | 2 | 3 | 3 | 4 |
| Drive2 counter: | 5 | 6 | 6 | 7 | 7 | 8 | 8 |

Whenever a counter incrementation is detected, the received value should be regarded as more recent, while the second received value should be regarded as older and corrected accordingly.

Thus, in in accordance with disclosed embodiments of the invention, on the one hand, an asynchrony between the communication cycle and a cyclic, but not clock-synchronous, safety cycle as described above can be taken into account and, on the other hand, safety-oriented drive-side controls, clock-synchronous when considered in isolation, can be synchronized with the communication cycle by adjusting the measurement values.

In accordance with a further embodiment, position values, velocity values, force values, temperature values, fill level values, current values or voltage values can be acquired as measurement values. The position, velocity, force, temperature, level, current, or voltage values are combined to obtain an overall position, velocity, force, temperature, level, current or voltage value as a monitoring value. For example, values are recorded at diverse points in a production process on a plant, and are then processed to form an overall measurement value, in order to then have this value monitored via a safety function as a monitored value. The presently disclosed embodiment is particularly advantageous when a state is to be monitored as the overall monitoring variable, which has dependencies on the various measurement values so that the temporal synchrony of the measurement values is important for the accuracy of the monitoring value. For example, from the individual at least partially adjusted current values a force value is determined as the value to be monitored, which with the adjustment carried out on the individual current values (if necessary) to a common counter incrementation, enables the actual force value present at each time to be monitored very accurately.

In accordance with one embodiment, based on the adjusted measurement value(s) and values derived from the measurement value(s) associated with the maximum counter increment, the safety function forms the at least one monitoring value. Advantageously, the monitoring value is determined exclusively from, or also in addition to, variables derived from the measurement values, which have been adjusted where necessary.

For example, velocity values are derived from adjusted position values and from the position values that do not require adjustment. For example, these velocity values are input into the safety function to execute the safety function “Safe velocity”, which monitors whether an end effector exceeds a limit velocity and, if necessary, initiates measures such as stop operations.

In accordance with another embodiment, a parameterizable limit value is set up, which defines a permissible difference of respective counter increments. Thus, a form of upper limit for an asynchrony can be set. A maximum permissible deviation between respective cycle counter differences is introduced, above which no further adjustment of the measurement values in accordance with the disclosed methods should occur, but instead, for example, an error message should be output and/or a stop function should be executed. Thus, a certain fluctuation of the individual measurement values in terms of time is tolerated and advantageously corrected, but only up to the defined limit value. For example, this is specified and defined by the controller for each system or when the system is set up. Thus, the filter functionality is limited, which represents an advantageous extension of the safety functions provided, for example, in case of faults such as failed sensors.

In accordance with a further embodiment, the measurement values that do not have the maximum counter increment are adjusted by performing an extrapolation based on previously determined or previously adjusted measurement values. For example, a linear extrapolation is performed. For example, a measured position value that does not have the maximum counter increment is extrapolated. For this purpose, for example, a velocity that can be determined based on the latest position values and time increments, which thus represents, for example, the most up-to-date axial instantaneous velocity, is assumed for the linear extrapolation of the position. Even for an axis that is running unevenly, for example, and at a given speed fluctuates slightly around this speed in each cycle, i.e., accelerates or decelerates slightly in each cycle, a linear extrapolation is simple to perform in comparison with, for example, a quadratic extrapolation (taking instantaneous acceleration into account), because transient accelerations do not have an effect here. However, it is also possible to extrapolate with higher-order polynomials, which take instantaneous acceleration, jerk, etc. into account. For example, in a quadratic extrapolation three position values, namely from the current cycle and the last two cycles, are included in the calculation and updated in each cycle.

In an embodiment, the safety function initiates safety functions depending on the at least one monitoring value. Typical safety functions are the braking of participating movement axes to travel at reduced speed in certain zones, or initiating stop operations to avoid hazards in collision regions. Likewise, alarm outputs or messages can be provided, for example, in the event of temperature or pressure violations resulting from the individual measurement values due to the monitoring value.

In accordance with another embodiment, the safety function calculates an error which is taken into account when monitoring the monitoring value. The error takes into account the inaccuracy that results from the adjustment of the measurement value(s). For example, an error due to the extrapolation is estimated. Advantageously, the errors resulting from the derivation of monitoring values from the adjusted measurement values are also taken into account at the same time.

The objects are further achieved in accordance with the invention by a safety-oriented controller for synchronizing measurement values delivered in an individual measurement phase, where the measurement values are processed by the safety-oriented controller in a monitoring phase in accordance with a safety function, where the safety-oriented controller is configured to compare individual counter increments of the measurement values with one another in a current monitoring cycle of the monitoring phase, in comparison with a previous monitoring cycle, and to determine a maximum counter increment, to adjust the measurement values that do not have the maximum counter increment on the basis of the maximum counter increment, and based on the adjusted measurement value(s) and the measurement value(s) associated with the maximum counter increment to form at least one monitoring value via the safety function.

For example, the safety-oriented controller is configured to form the monitoring values during ongoing operation of a device such as a kinematics, a robot, a machine tool or other machine controlled by the safety-oriented controller and, depending on whether these are within an expected or permissible range or value range, to trigger a safety function. The safety function is also triggered, for example, by the safety-oriented controller and according to defined routines, which includes in particular a down-regulation of the speeds of moving parts or switching of drives to a de-energized or torque-free state.

For example, it may be a safety-oriented controller that controls various drive axes. For example, the drive axes have independent, separate crystals each with their own time base, which are not necessarily cycling at the same rate, i.e., the axes do not have a common clock, i.e., are asynchronous. For example, the various drive axes are actuated to achieve by interaction a common movement of a part or tool or robot end effector. Its movement in the Cartesian space, which depends on the various drive axes, is monitored. The proposed safety-oriented controller allows the information of the individual axes, i.e., the respective measurement values, to be processed together, taking into account a consistent time, to form a monitoring value that enables a reliable monitoring.

In accordance with one embodiment, the safety-oriented controller is configured to implement any of the above-described embodiments of the method steps via a processor and associated memory.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below on the basis of exemplary embodiments and with the aid of the figures, in which:

FIG. 1 shows a schematic diagram to illustrate the method in accordance with a first exemplary embodiment of the invention;

FIG. 2 shows a schematic illustration of a graphical plot of a monitoring value in accordance with the prior art;

FIG. 3 shows a schematic illustration of a graphical plot of a monitoring value in accordance with a second exemplary embodiment of the invention.

### DETAILED DESCRIPTION OF THE EXEMPLARY EMBODIMENTS

In the figures, functionally equivalent elements are provided with the same reference numerals, unless otherwise indicated.

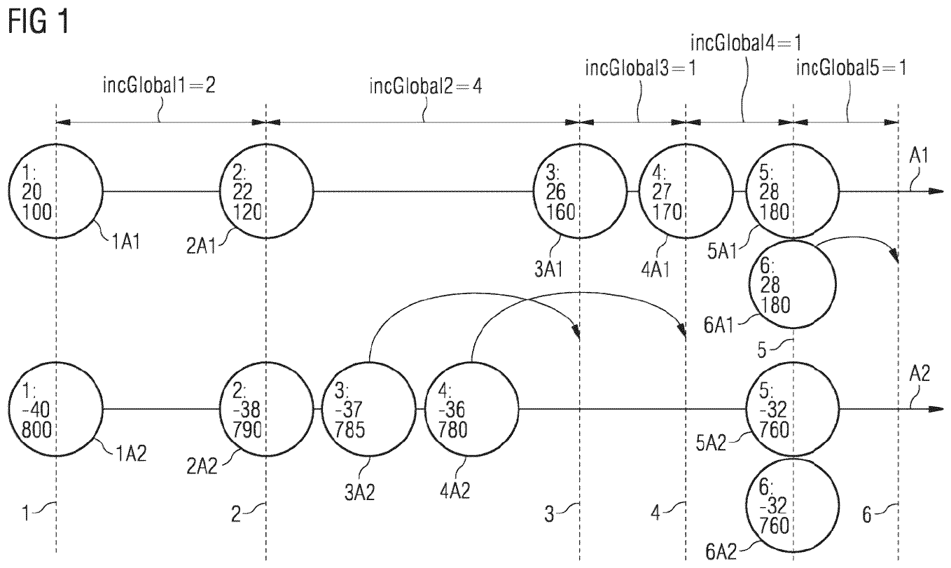

In FIG. 1, the operating principle of a software-implemented telegram filter in accordance with a first exemplary embodiment of the invention is shown.

According to the first exemplary embodiment, measurement values of multiple axes A1, A2 and in particular their axis telegrams are kept consistent with each other in time with a telegram filter. The measurement values are position information for the individual axes. The telegram filter is implemented in a safety-oriented controller, which is provided for the movement and monitoring of the movement of a multi-axis kinematics driven by the axes.

For the sake of simplicity, FIG. 1 shows only two axes A1 and A2 with their respective measurement values, telegrams received from these by a controller, and their adjustments. Applications often involve a large number of axes, all of which are kept consistent with each other, in particular according to the example shown.

The vertical dashed lines 1, 2, 3, 4, 5, 6 belong to six safety cycles selected as examples. These cycles are specified by the safety-oriented controller. For each safety cycle, the telegrams received from the axes are processed to form a monitoring value.

The safety cycles are equidistant, especially in the time base of the safety-oriented controller. In FIG. 1, the clock limits are shown spaced apart so as to show clearly the temporal relationship of the measurement values received from the axes to each other.

The telegram 1A1 received from axis A1 in the first safety cycle 1 has the time stamp or counter value 20 together with position 100. The telegram 1A2 received from axis A2 in the first safety cycle 1 has the time stamp or counter value −40 together with position 800. These values are used as quasi-starting values and are assumed by the safety-oriented controller to be given and correct and taken as a basis for determining the monitoring value.

If two different telegrams of the respective axis A1 or A2 are present in two consecutive safety cycles, their counter values in implementations differ by a specific increment i≥0, iεN, where i depends on the clock-rate ratio of bus clock to safety clock. In the event of oversampling, the same axis telegram may have been sampled in two consecutive safety cycles. This is referred to as telegram repetition, i is then zero and the same position value from the previous cycle is present again, followed by further implementations in connection with the sixth safety cycle 6.

In embodiments, the cycle counters run in a number ring, i.e., they have maximum and minimum values and upon reaching these values, jump from the maximum limit to the minimum limit, for example. This can be detected from the size of the jump or via overflow detection, so that the correct telegram increment can also be determined and the official counter value jumps from positive to negative in these special cycles.

In the case of different telegrams and also in general, because the existence of a telegram repetition is not known in advance, it is first determined among all axes A1, A2 which axis carries the most up-to-date time stamp, i.e., the maximum time increment is sought by comparing the respective counter increments of the measurement values in the current safety cycle in comparison with a previous safety cycle.

The maximum time increment, hereafter referred to as the global time increment incGlobal, among all axes is calculated as follows:
1.) incGlobal=max_k{counterCurrent_k−counterAdaptedPrevious_k}, with incLocal_k=counterCurrent_k−counterAdaptedPrevious_k for any axis k, where the following definitions apply:
counterCurrent: counter received in the current cycle. counterAdaptedPrevious: counter value, possibly adapted in the previous cycle.
incGlobal: global time increment re-calculated cyclically for all axes for each safety cycle.

The following steps are also performed for each axis (the index k is omitted for brevity):
2.) If counterDiff: =counterCurrent−counterAdaptedPrevious>0, then update the axial instantaneous velocity v, with v:=(posCurrent−posPrevious)/counterDiff

The following definitions apply:
counterPrevious: counter received from the previous cycle.
posCurrent: received measurement value, in this case position value, in the current clock cycle.
posPrevious: received position value from the previous cycle.

If incLocal==incGlobal, then the position transmitted with the telegram is passed on without extrapolation.

Based on FIG. 1, it can be seen that the position values of both axes A1, A2 are passed on unchanged in the second cycle, because the two telegrams 2A1 and 2A2 are globally exactly aligned in time. Both counter values have been incremented by two units, so that the two axes A1 and A2 were temporally synchronous. The global time increment incGlobal is therefore 2 for both.

Otherwise, the position is extrapolated based on the last determined velocity v, specifically for the axes for which the actual time increment is smaller than incGlobal.

The adjusted timestamp or counter value (counterAdapted) of each individual telegram is ultimately derived from the globally determined time increment IncGlobal.
5.) counterAdapted=counterAdaptedPrevious+incGlobal.

This means that via the telegram filter, all axis counters increment artificially in each safety cycle by the same time increment incGlobal. The position values of axes A1 and A2 are thus synchronized to a common point in time.

Ideally, this can occur in the second safety cycle 2 as in the exemplary embodiment shown, all telegrams already have the same point in time and are therefore consistent within the group. Here, all position values can be forwarded to the further calculation without manipulation. However, in asynchronous operation this will only be the case randomly and with a very small number of measurement values.

Otherwise, the incrementing by the global time increment is forced, in particular by subsequent extrapolation with order>1, i.e., better accuracy than with a pure linear extrapolation, similar to the Kalman principle. First, the newly measured position (posCurrent) and the linear extrapolated position are averaged based on the last cycle (posOutPrevious+v*incLocal): posBase: =½*(posCurrent+(posOutPrevious+v*incLocal)), with the definitions:
posBase: pre-filtered support position.

This makes posBase the starting position for the extrapolation over the period by which this axis lags behind (i.e. incGlobal−incLocal).
posOutPrevious: position adapted in the previous cycle.

The extrapolated axis position posOut evaluates to:
posOut: =posBase+v*(IncGlobal−incLocal).

The position of axis A1 from telegram 3A1 in the third cycle 3 is passed on unchanged because the axis A1 is the most recent. On the other hand, the position of axis A2 must be extrapolated based on the third telegram 3A2. The time stamp −37 lags behind the current time by 3 increments and is adjusted to −34. Using the above extrapolation rule, position 770 is output instead of 785. Similarly, with the fourth telegram 4A2 in the fourth cycle 4, the position for axis A2 must be extrapolated to 765 and the counter value must be adjusted to −33. Again, the telegram 4A1 of the axis A1 is the more recent. This is by no means necessarily the case, but for each safety cycle any axis, and in particular a different axis every safety cycle, can represent the one with the most recent telegram.

In cycle 5, both axes A1, A2 are exactly the same in time, so that here only the positions of the respective telegrams 5A1, 5A2 must be forwarded.

In cycle 6, the same telegram from cycle 5 5A1, 5A2 is again received on both axes A1, A2 as a new telegram 6A1, 6A2. It is assumed for the safety-oriented monitoring that this is an outdated statement about the positions of the axes A1 and A2, so that both axes are extrapolated here into the future by a time step incGlobal=1 with respect to the current speed. This is particularly necessary if the safety-oriented monitoring refers to a derived value of the measurement values, for example, the velocity. For a time increment of 0, the variable would then not be differentiable at this point and no valid values could be determined.

All counter and extrapolation values are listed in the following table.

| Cycle: | 2 | 3 | 4 | 5 | 6 |
|---|---|---|---|---|---|
| counterAdaptedA1: | 22 | 26 | 27 | 28 | 29 |
| posOutA1: | 120 | 160 | 170 | 180 | 190 |
| counterAdaptedA2: | −38 | −34 | −33 | −32 | −31 |
| posOutA2: | 790 | 770 | 765 | 760 | 755 |

The axis velocities v are retained in each cycle despite extrapolation:
v=(posOut−posOutPrev)/incGlobal.

In the example, the velocity for axis A1 is 10 position units per drive cycle and for A2—5 units per drive cycle.

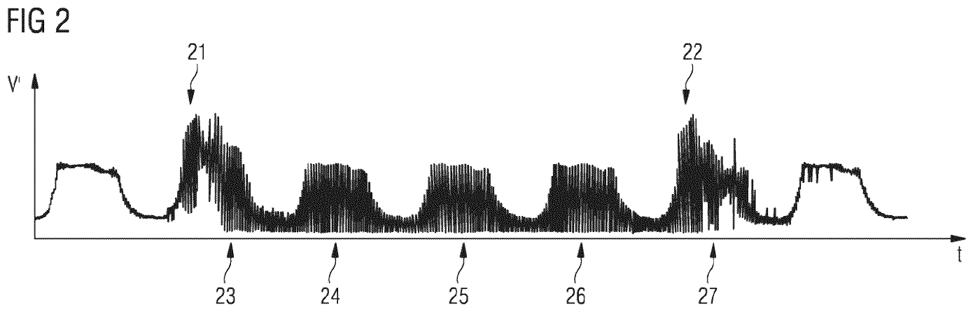

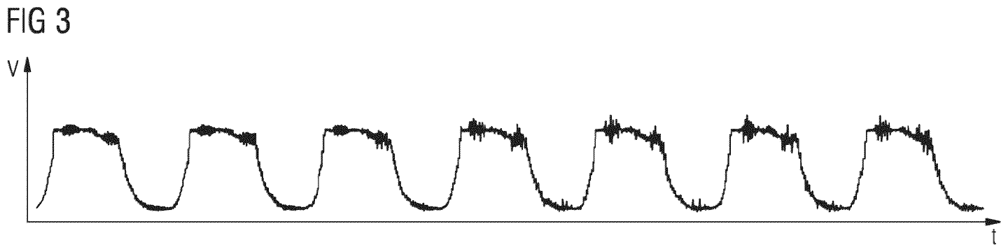

FIG. 2 illustrates how monitoring values, which result from multiple measurement values as well as derivatives of these and which are calculated for performing safe monitoring in the operation of a driven machine, behave in the prior art. Here, the monitoring values are calculated, for example, from measurement values received and recorded over time, and recorded over the time t result in the graph of FIG. 2. The Cartesian velocity v′ on the flange of a SCARA 4-axis robot is evaluated as a monitoring value. The graphical plot shows the calculated Cartesian velocity v′ associated with a periodic movement of the flange along an ellipse.

The periodicity of the velocity v′ can be seen, but also a superimposed jitter that does not correspond to the actual velocity and that prevents meaningful monitoring. The jitter is so severe that the velocity curve in the illustration can no longer be resolved. At higher temporal resolution, the fluctuations would be visible as separate swings. In particular, identified overshoots 21, 22 in the Cartesian velocity v′ in the second and the sixth illustrated movement cycle lead to the initiation of an unnecessary stop operation: a limit value for initiating a stop operation should advantageously be as close as possible to the intended Cartesian velocity. For example, the limit value follows a time curve with the same periodicity of the Cartesian velocity and is just above the expected velocity at all times. For example, this limit value is accordingly placed such that it would be exceeded in the second and sixth movement cycles by the calculated Cartesian velocity v′ in the monitoring case.

Thus, a safety function is initiated in each case that is not necessary, since the actual Cartesian velocity at the time of an overshoot was lower than the calculated Cartesian velocity v′ with the overshoots 21, 22. Similarly, due to the downward fluctuations 23, 24, 25, 26, 27, the calculated velocity is repeatedly below the actual velocity of the flange, so that a speed that is too low is incorrectly determined and thus potential dangerous situations would not be detected in a hazard assessment based on the determined velocity.

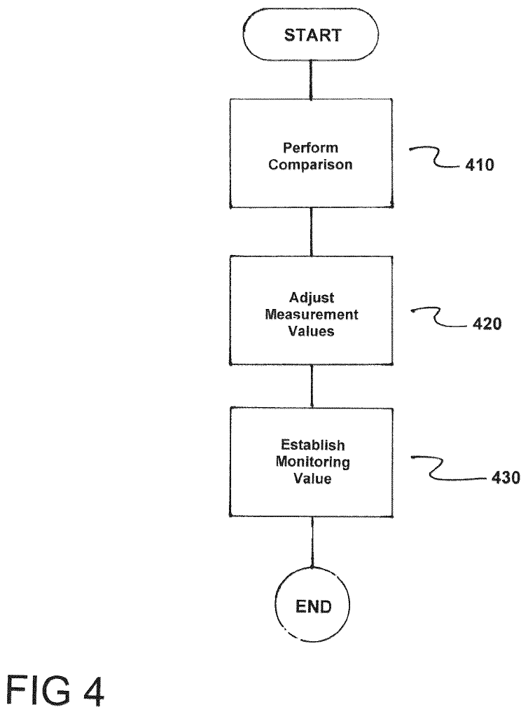

For the same scenario, FIG. 3 shows the trace of the monitoring value of the Cartesian velocity v in accordance with a second exemplary embodiment of the invention, otherwise analogous to the Cartesian velocity v′ shown in FIG. 2.

In accordance with the second exemplary embodiment, a synchronization is applied to the received telegrams with the position values, which extrapolates all positions to the time of the most recent counter value. Only with these synchronized position values is the respective Cartesian velocity present at the flange calculated as the monitoring value. The Cartesian velocity v determined based on the synchronized positions shows the smoothed curve shown in FIG. 3. It can be seen that the periodic curve shows hardly any distortion due to jitter.

Monitoring of the Cartesian velocity to prevent impermissibly high speeds, for example in pre-defined zones, is possible with significantly higher accuracy and reliability by adjusting the position values.

In order to increase the precision of the velocity monitoring further, an error analysis is also performed.

The extrapolation assumes that the axis continues to move at the last known instantaneous velocity for the time period to be extrapolated. This can lead to position errors if the axis accelerates or decelerates over time. Four cases must be distinguished to determine the axis position error:
1.) The telegram in the previous cycle is up-to-date and the following applies: posOutPrev=posPrev, counterAdapted=counterPrevious AND there is a telegram repeater in the current cycle: posCurrent=posPrev and counterCurrent=counterPrev.

Therefore, it follows that counterDiff=counterDiffToAdapted=0. The position error here is given by
pe=a/2*(counterIncGlobal)²,
where the typical or maximum axis acceleration can be used for a.
2.) The telegram in the previous cycle is up-to-date and the following applies: posOutPrev=posPrev, counterAdapted=counterPrevious AND the telegram in the current cycle is delayed: counterDiff=counterDiffToAdapted<counterIncGlobal.

For the position error pe it follows that:
pe=a/2*(counterIncGlobal−counterDiff)².
3.) The telegram in the previous cycle and the telegram in the current cycle are delayed AND there is no telegram repeater in the current cycle. With pePrev (position error in the previous cycle) the following applies for the position error:
pe=a/2*(counterIncGlobal−counterDiffToAdapted)²+½*pePrev.
4.) The telegram in the previous cycle and the telegram in the current cycle are delayed AND a telegram repeater is present in the current cycle. posCurrent=posPrevious, counterCurrent=counterPrevious:

The position error evaluates to
pe=½*pePrev+a/2*(½*counterDiffToAdapted2+(counterIncGlobal−counterDiffToAdapted)²).

If the maximum time offset among all axes allowedCycleDiff is additionally limited, the position error can be estimated upwards. Compliance with this constraint is also monitored.

The following applies:
a.) (counterIncGlobal−counterDiffToAdapted)<allowedCycleDiff and
b.) |counterDiffToAdapted|≤allowedCycleDiff

Furthermore, for a simplified error estimate posBase=posCurrent can be used, so that the error term from the previous cycle pePrev can be omitted.

In summary, this results in the following upper limit for cases 2.) to 4.):
pe<¾*a*allowedCycleDiff²

Case 1 can be summarized to:
pe<½*a*(max(allowedCycleDiff, 2*i))².

For example, for a 6-axis robot with a payload of 5 kg and a range of 0.9 m, with maximum axial acceleration of axis 1=288°/s² or 0.288 millidegrees/ms² and allowedCycleDiff=2 and a duration per increment ti of 2 ms, using the above error formula pe<¾*a*(allowedCycleDiff*ti)² and assuming that allowedCycleDiff is greater than or equal to 2*i, the resulting maximum position error of axis 1 amounts to 3.456 millidegrees.

This position error analysis is advantageously performed for all axes and is also taken into account in an error propagation estimation for the Cartesian velocity. Accordingly, a limit value for monitoring the velocity in accordance with the error for this is reduced to ensure a sufficiently safe velocity monitoring.

The disclosed method and associated control system enable and ensure a reliable velocity and position monitoring in asynchronous axis operation, in particular in the field of mobile kinematics. Safe position and velocity monitoring is thus also possible when the bus clock is not synchronized with the safety clock, i.e., in asynchronous axis mode. This means that there is no need for an initial situation in which axis telegrams are read and processed by the bus in each safety cycle at equidistant time points. A solution for asynchronous axis operation has thus also been found, especially for the safe position and speed monitoring of movements in three-dimensional, Cartesian space.

FIG. 4 is a flowchart of the method for synchronizing measurement values posCurrent supplied in a respective measurement phase, where the measurement values posCurrent are processed by a safety-oriented controller in a monitoring phase in accordance with a safety function. The method comprises comparing respective counter increments incLocal of the measurement values posCurrent compared with one another in comparison with a previous monitoring cycle during in a current monitoring cycle of the monitoring phase, and determining a maximum counter increment incGlobal, as indicated in step 410.

Next, measurement values posCurrent that do not have the maximum counter increment incGlobal are adjusted based on the maximum counter increment incGlobal, as indicated in step 420.

Next, at least one monitoring value is established by the safety function based on the adjusted measurement value(s) posOut and the measurement value(s) posCurrent associated with the maximum counter increment incGlobal, as indicated in step 430.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method for synchronizing measurement values supplied in a respective measurement phase, the measurement values being processed by a safety-oriented controller in a monitoring phase in accordance with a safety function, the method comprising:
comparing respective counter increments of the measurement values with one another in comparison with a previous monitoring cycle during a current monitoring cycle of the monitoring phase, and determining a maximum counter increment;
adjusting measurement values which do not have the maximum counter increment based on the maximum counter increment; and
establishing, by the safety function, at least one monitoring value based on the adjusted measurement values and the measurement values associated with the maximum counter increment.

16. The method as claimed in claim 15, wherein each of the measurement values is delivered in a common measurement phase or in different measurement phases.

17. The method as claimed in claim 15, wherein the monitoring phase differs from the measurement phase or at least from individual measurement phases.

18. The method as claimed in claim 16, wherein the monitoring phase differs from the measurement phase or at least from individual measurement phases.

19. The method as claimed in claim 15, wherein the measurement values are supplied to the safety-oriented controller via a telegram.

20. The method as claimed in claim 15, wherein the measurement values of respective axes are delivered to a multi-axis kinematics.

21. The method as claimed in claim 20, wherein the safety-oriented control system receives the measurement values from distributed measurement systems.

22. The method as claimed in claim 15, wherein position values, velocity values, force values, current values or voltage values are acquired as measurement values.

23. The method as claimed in claim 15, wherein the safety function forms the at least one monitoring value based on the adjusted measurement values and values derived from the measurement values associated with the maximum counter increment.

24. The method as claimed in claim 15, wherein a parameterizable limit value is set up, which defines a permitted difference of respective counter increments.

25. The method as claimed in claim 15, wherein the measurement values that do not have the maximum counter increment are adjusted by performing an extrapolation based on previously determined or previously adjusted measurement values.

26. The method as claimed in claim 15, wherein the safety function initiates safety functions depending on the at least one monitoring value.

27. The method as claimed in claim 15, wherein an error is calculated by the safety function, which is taken into account when monitoring the monitoring value.

28. A safety-oriented controller for synchronizing measurement values delivered in a respective measurement phase, the measurement values being processed by the safety-oriented controller in a monitoring phase in accordance with a safety function, the safety-oriented controller comprising:
a processor; and
memory;
wherein the safety-oriented controller is configured to:
compare respective counter increments of the measurement values during a current monitoring cycle of the monitoring phase in comparison to a previous monitoring cycle and to determine a maximum counter increment;
adjust the measurement values that do not have the maximum counter increment based on the maximum counter increment; and
form at least one monitoring value based on the adjusted measurement values and the measurement values associated with the maximum counter increment via the safety function.

29. The safety-oriented controller as claimed in claim 28, wherein the safety-oriented controller is further configured to deliver each of the measurement values in a common measurement phase or in different measurement phases.

30. The method as claimed in claim 28, wherein the monitoring phase differs from the measurement phase or at least from individual measurement phases.

31. The safety-oriented controller as claimed in claim 29, wherein the monitoring phase differs from the measurement phase or at least from individual measurement phases.

32. The safety-oriented controller as claimed in claim 28, wherein the safety-oriented controller is further configured to supply the measurement values to the safety-oriented controller via a telegram.

33. The safety-oriented controller as claimed in claim 28 wherein the measurement values of respective axes are delivered to a multi-axis kinematics.

34. The safety-oriented controller as claimed in claim 20, wherein the measurement values are received from distributed measurement systems.

35. The safety-oriented controller as claimed in claim 15, wherein position values, velocity values, force values, current values or voltage values are acquired as measurement values.

36. The safety-oriented controller as claimed in claim 28, wherein the safety function forms the at least one monitoring value based on the adjusted measurement value(s) and values derived from the measurement values associated with the maximum counter increment.

37. The safety-oriented controller as claimed in claim 28, wherein the safety-oriented controller is further configured to set up a parameterizable limit value which defines a permitted difference of respective counter increments.

38. The safety-oriented controller as claimed in claim 28, wherein safety-oriented controller is further configured to perform an extrapolation based on previously determined or previously adjusted measurement values to adjust the measurement values that do not have the maximum counter increment.

39. The safety-oriented controller as claimed in claim 28, wherein the safety function initiates safety functions depending on the at least one monitoring value.

40. The safety-oriented controller as claimed in claim 15, wherein an error is calculated by the safety function, which is taken into account when monitoring the monitoring value.
